(19) United States
(12) Patent Application Publication
(10) Pub. No.: US 2026/0007148 A1
(43) Pub. Date: Jan. 8, 2026

(54) TEXTURIZED FORMED PLANT PROTEIN PRODUCT AND METHOD FOR MANUFACTURING THE SAME

(71) Applicant: BioMush Oy, Espoo (FI)

(72) Inventors: Reetta ANDOLIN, Helsinki (FI); Outi MÄKINEN, Helsinki (FI)

(21) Appl. No.: 19/102,864

(22) PCT Filed: Aug. 14, 2023
(86) PCT No.: PCT/FI2023/050466

§ 371 Date: Feb. 11, 2025

(30) Foreign Application Priority Data
Aug. 12, 2022 (FI) 20225722

(51) Int. Cl. A23J 3/22; A23J 3/14; A23L 27/10; A23L 31/00

(52) U.S. Cl. CPC A23J 3/227; A23J 3/14; A23L 27/10; A23L 31/00

(57) ABSTRACT

The disclosure relates to methods of manufacturing texturized formed plant protein products, texturized formed plant protein products produced by the method, and food products comprising the texturized formed plant protein product.

### FIELD OF THE INVENTION

The invention relates to products comprising plant-based protein, and particularly to methods of manufacturing texturized formed plant protein products, texturized formed plant protein products produced by the method, and food products comprising the texturized formed plant protein product.

### TECHNICAL BACKGROUND

The quality of plant-based meat analogues has improved tremendously over the past decade, which has led to massive growth in their popularity. To obtain desired texture and mouthfeel, plant proteins are currently either texturized by protein texturization extrusion, which is a thermomechanical process that aligns proteins into fibrillar textures. High moisture extrusion process produces fibrillar and chewy textures without the need of additives, but the process requires highly purified proteins and high investments.

As an alternative to protein texturization extrusion, to bind ingredients together and give the product a meat-like bite a texturized structure can be obtained by using methyl cellulose which is a heat-gelling, chemically modified polysaccharide.

As a further alternative, fungal texturization can be used. Fungal mycelia can form fibrillar and oriented textures by nature. Fungal texturization offers a natural and energy-efficient way of creating chewable textures, as the single-cell growth is the texturization method. Traditionally, the challenge of the utilisation of fungus texturization has been bitterness, lack of taste and dryness.

International patent application publication WO 2020/232347 A1 discloses an example of fungal fermentation texturization. The process uses a sterilised mixture of grains and plant protein isolate or concentrate. The substrate is inoculated with filamentous fungi and cultured in a single step for 7-10 days until a mycelial network has solidified the product. Sterilization is an energy-intensive method step that requires a high temperature and/or high pressure treatment of the substrate.

Further examples of fungal texturization include tempeh and oncom. Tempeh is a traditional Indonesian soy-based product, which is made by a controlled fermentation process that binds whole soybeans and possible further ingredients into a cake form, using Rhizopus fungi (Jelen et al., 2013). However, the taste profile is challenging due to the earthy flavor and lack of saltiness. In addition, the texture is firm rather than juicy. Oncom is also a traditional Indonesian product. Black oncom is fermented using Rhizopus oligosporus while red oncom is fermented using Neurospora intermedia var. oncomensis.

### BRIEF DESCRIPTION OF THE DISCLOSURE

An object of the present disclosure is to provide a method of manufacturing a texturized formed plant protein product so as to solve the above problems. The method disclosed herein involves a two-step fungal fermentation of a bed substrate, whereby the first fermentation step produces a pre-fermented bed substrate that may be shaped into a formed product, and the second fermenting step solidifies the formed product into a texturized formed plant protein product. It is also provided a texturized formed plant protein product produced by the method, and a food product comprising the texturized formed plant protein product.

The object of the disclosure is achieved by a method of manufacturing a texturized formed plant protein product, a texturized formed plant protein product produced by the method, and a food product comprising the texturized formed plant protein product which are characterized by what is stated in the independent claims. The preferred embodiments of the disclosure are disclosed in the dependent claims.

### LIST OF DRAWINGS

The invention is described in more detail below in the detailed description, with reference to the preferred embodiments contained in the appended drawings, of which:

FIG. 1 presents a flow diagram of an exemplary manufacturing process of a texturized formed plant protein product;

FIG. 2 illustrates test results for extractable glutamic acid in an unfermented substrate, in a pre-fermented substrate and in the texturized plant protein product;

FIGS. 3A and 3B illustrate cross-sections of the texturized plant protein product (microscope with 10× magnification);

FIG. 3C is a picture of pre-fermented substrate mass with other ingredients before final fermentation;

FIG. 3D is a picture of substrate mass with other ingredients after final fermentation;

FIGS. 3E and 3G are pictures of texturized plant protein products before frying;

FIGS. 3F and 3H are pictures of texturized plant protein products after frying;

FIG. 4 illustrates results of a sensory evaluation of plant-based patties produced with the method disclosed herein.

### DETAILED DESCRIPTION OF THE DISCLOSURE

As used herein, the terms “plant-based protein”, “plant protein” and the like refer to protein derived from plant material including cereals, legumes, oil seeds, nuts, pseudocereals, tubers, fruits and vegetables. Additionally, as used herein, plant-based protein may include fungal protein originating from fungal growth in or on a plant-based substrate.

In an aspect, the disclosure relates to a method of manufacturing a texturized formed plant protein product, comprising the steps of:
i) providing a bed substrate comprising plant-based protein-containing particles, said particles forming a mass of material having a packing density comprising internal free spaces;
ii) introducing at least one filamentous fungal culture into the bed substrate by mixing such that the fungal culture at least partly enters the internal free spaces;
iii) incubating to convert the bed substrate to a pre-fermented bed substrate in which the fungal culture has at least partly reached mycelial stage;
iv) shaping the pre-fermented bed substrate to a formed product in a manner conserving the packing density such that the formed product has internal free spaces for filamentous fungal growth; and
v) fermenting the formed product to provide a texturized formed plant protein product by a substantially solidifying filamentous fungal growth via the internal free spaces.

The inventors have surprisingly found that a two-step fermentation, whereby the first fermentation step produces a pre-fermented bed substrate that may be shaped into a formed product, and the second fermenting step solidifies the formed product into a texturized formed plant protein product, producing a texturized formed plant protein product that has improved organoleptic properties. The texturized product has a more pleasant texture and flavor than a conventional product texturized using a chemical binder, methyl cellulose. The product has firmness similar to or slightly better than the conventional product, while maintaining a pleasant, non-chewy and non-leathery texture. The pleasant texture is due to maintaining the packing density and internal free spaces while shaping the product, whereafter the formed product is solidified in the second fermentation by filamentous fungal growth via the internal free spaces.

As used herein, the term “internal free spaces” refers to empty spaces between plant-based protein-containing particles of the substrate bed. That is, there are cavities and channels amidst the particles. These cavities and channels are typically filled with air and/or moisture from the bed substrate and facilitate efficient mass transfer of oxygen and/or nutrients to the growing fungal culture. Size of the internal free spaces is affected by packing density of the substrate bed and the plant-based protein-containing particles therein. Preferably, the packing density is sufficiently low to enable air circulation through the mass of material in the bed substrate, in other words the mass of material is being aerated.

Herein, it is meant by a substantially solidifying filamentous fungal growth via the internal free spaces that mycelia grow to essentially or substantially fill the internal free spaces within the bed substrate. That is, the internal free spaces are filled at least in part by mycelia. As a consequence, a solidified, texturized formed plant protein product is obtained.

In the method disclosed herein, the filamentous fungal culture is introduced or inoculated into the bed substrate such that the fungal culture at least partly enters the internal free spaces. To achieve this, the bed substrate may be mixed to ensure distribution of fungal mass into at least part of the internal free spaces. As the fungus grows on and within the bed substrate, forming mycelia, the fungal biomass growth extends between and via internal free spaces and solidifies the formed product to provide a texturized formed plant protein product. In the first fermentation step iii) the fungal culture reaches mycelial stage at least in part but the pre-fermented bed substrate still remains nontexturized. The second fermentation step v) is where the solidification vie mycelial growth mainly occurs.

As used herein, the terms “bed substrate”, “substrate bed” and the like refer to a mass of material formed from or comprising plant-based material including cereals such as wheat, corn, oat, rice and barley; legumes such as soy, peas, beans, chickpea, lentils, lupins, and faba beans; oil seeds such as sunflower, rapeseed, flaxseed, hemp seed, cotton seed, sesame seed, and pumpkin seed; nuts such as almond, pistachio, cashew, walnut and peanut; pseudocereals such as quinoa, buckwheat, chia seed and amaranth; tubers such as potato; fruits; vegetables, and any mixtures thereof. The plant-based material is preferably food-grade and may originate from food processing industry, or be a side stream or a by-product of food processing industry, or a processed food product. The bed substrate is preferably of raw natural material, thus excluding vegetable protein isolates and concentrates.

In an embodiment, the bed substrate comprises at least 5% by weight carbohydrates, preferably at least 18% by weight carbohydrates. In another embodiment, pH of the bed substrate is in the range of 4.8 to 6.8. A sufficient amount of carbohydrates and/or suitable pH promote(s) fungal growth in the bed substrate.

In yet another embodiment, the bed substrate has a moisture content between 25% and 75% by weight, preferably 39% and 63% by weight, more preferably between 45% and 59% by weight. The moisture content gives suitable conditions for fungal growth and ensures efficient distribution of nutrients and/or oxygen.

In still another embodiment, the bed substrate comprises at least one component retaining moisture during the fungal growth, such as fiber. Such components maintain conditions suitable for fungal growth during the fermentation steps.

In the method disclosed herein, the pre-fermented bed substrate is shaped to a formed product in a manner conserving the packing density such that the formed product has internal free spaces for filamentous fungal growth. Shaping may be achieved by placing the pre-fermented bed substrate into a mold that provides the pre-fermented bed substrate a desired shape such as a sheet, a loaf, a patty or a ball. Shaping to a formed product in a manner conserving the packing density may be achieved by dosing bed substrate in trays or containers of desired shape without the use of vacuum or high shear, or by creating a sheet or mat with desired thickness. The pre-fermented bed substrate may be gently pressed into the mold to achieve a desired shape, packing density and/or size of internal free spaces. A skilled person can readily envisage manners of shaping and optionally pressing the pre-fermented bed substrate into a formed product. However, for example using vacuum dosing for forming the product is not suitable because employing a vacuum will extract all air from the bed substrate and potentially lead to too high packing density and collapse of the internal free spaces. By gentle pressing is meant that pressure is applied only to produce a desired shape to the product while maintaining the packing density and/or size of the internal free spaces.

In an embodiment, the packing density is sufficiently low to enable air circulation through the mass of material, in other words the mass of material is being aerated. The higher the packing density, the smaller the size of the internal free spaces.

The packing density is in steps i) and iv) generally between 0.20 and 0.40 kg/dm³, preferably between 0.23 and 0.31 kg/dm³ and most preferably between 0.26 and 0.28 kg/dm³. With these packing densities, it can be reliably prevented that the substrate bed turns dough-like and too dense for efficient mass transfer.

Size of the internal free spaces is also affected by particle size of the plant-based particles of the bed substrate. The larger the particles, the larger generally are the internal free spaces between and amidst the particles. In an embodiment, the plant-based particles in the bed substrate have a size distribution selected so that the internal free spaces allow mass transfer and substrate availability for the fungal culture.

In an embodiment, the plant-based protein-containing particles have a size distribution selected so that the internal free spaces allow mass transfer and substrate availability for the fungal culture.

In another embodiment, the internal free spaces have a diameter of 0.2 to 5 mm, preferably 0.5 to 5 mm. The size of the plant-based particles and/or packing density may be selected such that this desired size of internal free spaces is achieved.

In an aspect, the disclosed method further comprises the step of:
iii-a) combining the pre-fermented bed substrate, for adding flavor, with at least one ingredient comprising salt, resulting in a salt concentration of less than 3% by weight, preferably 0.1% to less than 3% by weight.

The salt is or comprises at least one of sodium chloride, potassium chloride, magnesium sulphate, or lysine hydrochloride. Step iii-a) is performed after step iii) and before step iv).

In an embodiment, the ingredient comprising salt comprises or consists of a plant-based puree or paste.

In another embodiment, the ingredient comprising salt may comprise an umami-containing fermented mashed biomass having moisture 50-85% by weight, preferably 68-85% by weight, and optionally further ingredients such as a plant-based puree or paste. This increased moisture content may improve the fermentation result of step v) and organoleptic properties such as tastiness of the texturized product.

Preferably, the pre-fermented bed substrate produced in steps i) to iii) of the method is or comprises a bed substrate removed from an umami sauce making process during ongoing fermentation, and the at least one ingredient comprising salt in step iii-a) is or comprises a press cake of the umami sauce making process. In this manner, it can be ensured that the fungal culture added in step ii) will not cause any surprisingly unpleasant change in taste when the pre-fermented bed substrate is combined with the at least one ingredient comprising salt in step iii-a). This results from the fact that in this case the same fungal culture has already consumed any available matter in the ingredient comprising salt added in step iii-a).

With the method comprising step iii-a), it becomes possible to further improve the taste of a texturized formed plant protein product. The products from previously known manufacturing methods, such as those disclosed in WO 2020/232347 A1, or tempeh and oncom from the traditional methods, have very little salt and thus an important component of taste is missing.

The inventors have realized that thanks to the pre-fermentation, the filamentous fungal culture survives the addition of salt, and thus the final fermenting step v) which is performed after the shaping step iv) succeeds. Salt addition has the effect of reducing and slowing down growth of the fungal culture. This reduces sporulation particularly during the second fermentation step and ensures that the fungus forms mycelia during the second fermentation step without producing spores. A textured product comprising mycelia and little or no sporulation has improved taste compared to a product with fungal spores.

In an embodiment, the fermentation in step v) is carried out for a period of time ranging from 12 hours to 7 days, preferably 12 hours to 24 hours. The selected time range is suitable for mycelial growth without substantial formation of spores, particularly when the at least one ingredient comprising salt is added before step v).

In another embodiment, the incubation in step iii) is carried out for at least 12 h or less than 24 h, preferably between 12 and 24 h. Performing this first fermentation for this range of time ensures the fungal growth has sufficient time to at least partly reach mycelial stage. Also, when the at least one ingredient comprising salt is added after pre-fermentation in step iii), performing the pre-fermentation for a sufficient amount of time ensures the fungal culture can withstand the increased salt conditions after adding the at least one ingredient comprising salt and fermentation can continue in step v) to provide the texturized product.

In an aspect of the disclosure, the bed substrate preferably comprises proteins suitable for releasing umami ingredients and wherein in the fermenting step vi), umami ingredients are released inside the formed plant protein product through fermentation by the fungal culture. In this manner, the final fermenting step can further improve the taste of the texturized formed plant protein product.

As used herein, the terms “umami ingredients”, “umami flavor”, “umami compounds” and the like refer to compounds that trigger the umami taste receptors. These include glutamate (a salt of glutamic acid), specific ribonucleotides, and glutamate salts including monosodium glutamate, potassium glutamate, and calcium glutamate.

In an embodiment, the bed substrate comprises plant protein suitable for releasing umami amino acids when the bed substrate comprises at least 1400 mg glutamic acid per 100 g of bed substrate, in other words 14 g glutamic acid per kg of bed substrate.

In an embodiment, in fermentation step v) the amount of extractable glutamic acid increases. Optionally, the amount of extractable glutamic acid in the texturized formed plant product is at least 4g/kg dry matter, preferably at least 5 g/kg dry matter. Additionally or alternatively, the amount of extractable glutamic acid in the texturized formed plant protein product is at least quadrupled compared to the amount of extractable glutamic acid in the bed substrate.

In an aspect, the method further comprises the step(s) of:
vi) heating the formed product, such as by frying or baking, to deactivate the filamentous fungal culture, and
vii) optionally adding spices, herbs or marinade.

Step vi) improves the storage life of the product and step vii) may further improve the taste of the product. If the solidified product after step v) contains non-solidified volumes, such as clusters or inclusions, preferably of vegetables, spices or fats, the juiciness of the product may be improved. Preferably, in this case, the non-solidified volumes are solidified in step vi).

In another aspect, the filamentous fungal culture is selected from a culture of Aspergillus, Rhizopus, Geotrichium, Penicillium, Lentinula, Pleurotus, Auricularia, Agaricus, Flammulina, Hericium, Clitocybe, Hypsizygus, Sparassis, Ustilago, Fusarium and any combination thereof, or comprises at least one Aspergillus subspecies. Generally, edible food-grade or food-safe filamentous fungi are utilized in the method disclosed herein.

In an embodiment, the filamentous fungal culture is or comprises Aspergillus oryzae.

The Aspergillus subspecies and in particular Aspergillus oryzae are a preferable choice as the filamentous fungal culture since they grow in mycelial stage very fast, have excellent hydration properties, and efficiently release the umami compounds in the bed substrate.

In an aspect, the disclosure relates to a texturized formed plant protein product produced by the method according to the above disclosure.

In an embodiment, the texturized formed plant protein product is a vegetable meat-imitation patty or a vegetable meat-imitation ball.

In another aspect, the disclosure relates to a food product comprising the texturized formed plant protein product. The food product may be any food product where the texturized formed plant protein product can be applied or incorporated.

The texturized formed plant protein product substantially consists of a bed substrate that has been solidified by growing filamentous fungal in the internal free spaces using the method according to the invention. The product is preferably a vegetable meat-imitation patty or a vegetable meat-imitation ball.

Our method enables the production of a pleasantly textured protein food product made from complete, minimally processed ingredients. The process is fast and does not require artificial additives or energy intensive processing steps. In the method, not only the pleasantly juicy and chewable, but not chewy or leathery texture is produced naturally. Also salt and umami may be incorporated within the structure of the product. The method can be used to produce fat-free or low-fat products but, alternatively, fat can easily be added to the recipe if preferred. The ingredient list is clean label and contains only natural substrates such as legumes, grains, vegetables, starter culture, salt and water, and optionally oil.

It is envisaged that in an embodiment, the method of the disclosure may comprise the following steps:
i) providing a bed substrate having a moisture content between 39% and 63% by weight, preferably between 45% and 59% by weight, comprising plant-based protein-containing particles, said particles forming a mass of material having a packing density comprising internal free spaces;
ii) introducing at least one filamentous fungal culture into the bed substrate by mixing such that the fungal culture at least partly enters the internal free spaces;
iii) incubating to convert the bed substrate to a pre-fermented bed substrate in which the fungal culture has at least partly reached mycelial stage;
iii-a) combining the pre-fermented bed substrate, for adding flavor, with at least one ingredient comprising salt, resulting in a salt concentration of less than 3% by weight; wherein the salt is or comprises at least one of sodium chloride, potassium chloride, magnesium sulphate, or lysine hydrochloride,
iv) shaping the pre-fermented bed substrate to a formed product in a manner conserving the packing density such that the formed product has internal free space for filamentous fungal growth; and
v) fermenting the formed product to provide a texturized formed plant protein product by a substantially solidifying filamentous fungal growth via the internal free spaces,
wherein in fermentation step v) amount of extractable glutamic acid increases, optionally wherein the amount of extractable glutamic acid in the texturized formed plant product is at least 4 g/kg dry matter, preferably at least 5 g/kg dry matter, or the amount of extractable glutamic acid in the texturized formed plant protein product is at least quadrupled compared to the amount of extractable glutamic acid in the bed substrate.

Terms such as “about”, “generally”, “substantially” and suchlike shall be understood with their function of modifying a term or value that is not absolute, but is not reported in the state of the art. Such terms shall be defined by the specific circumstances and by the terms that they are intended to modify according to the common acceptance of such terms in the specific field. They shall take into account at least the degree of experimental error expected, the technical error and the instrumental error for a given technique adopted to measure a value. Unless otherwise indicated, in the present description, singular forms such as “a”, “an” and “one” shall be understood to include plural forms, unless the context suggests otherwise.

It will be obvious to a person skilled in the art that, as technology advances, the inventive concept can be implemented in various ways. The invention and its embodiments are not limited to the examples described below but may vary within the scope of the claims.

### EXAMPLES

### Example 1

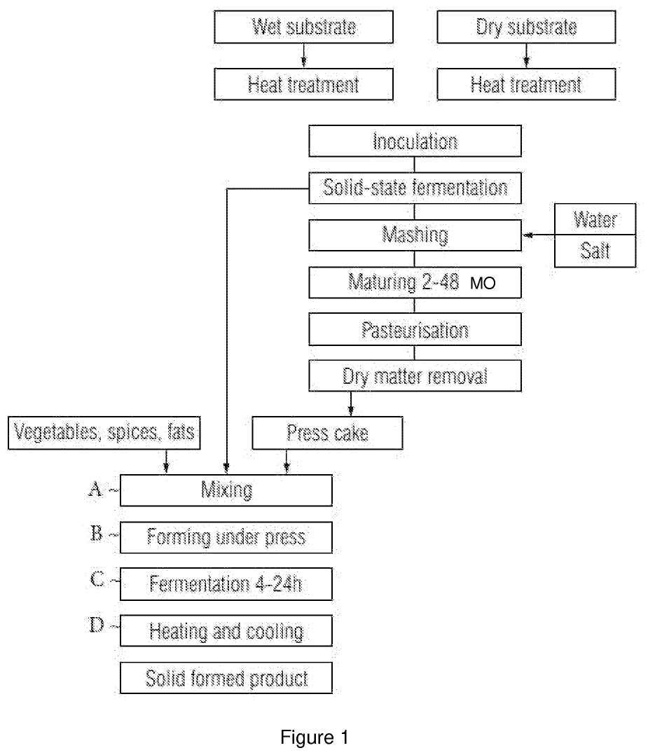

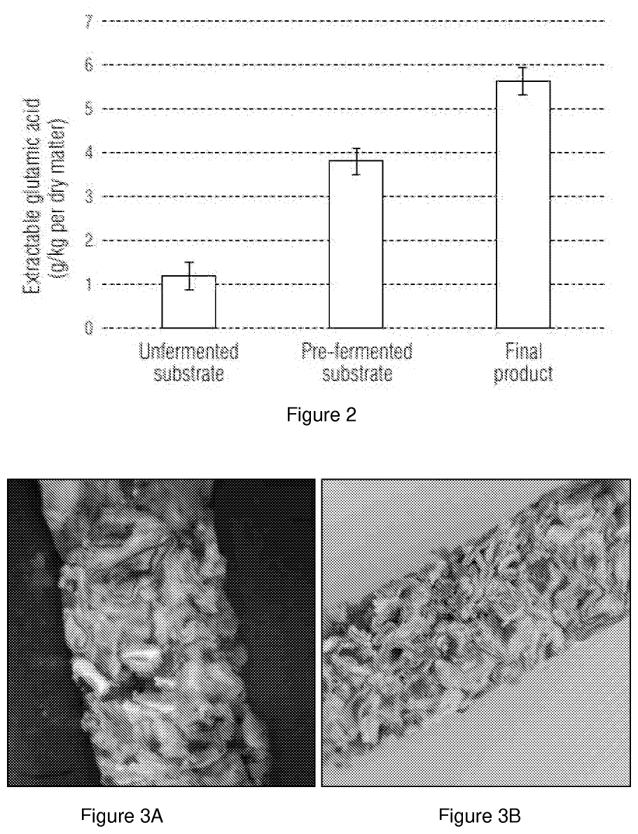

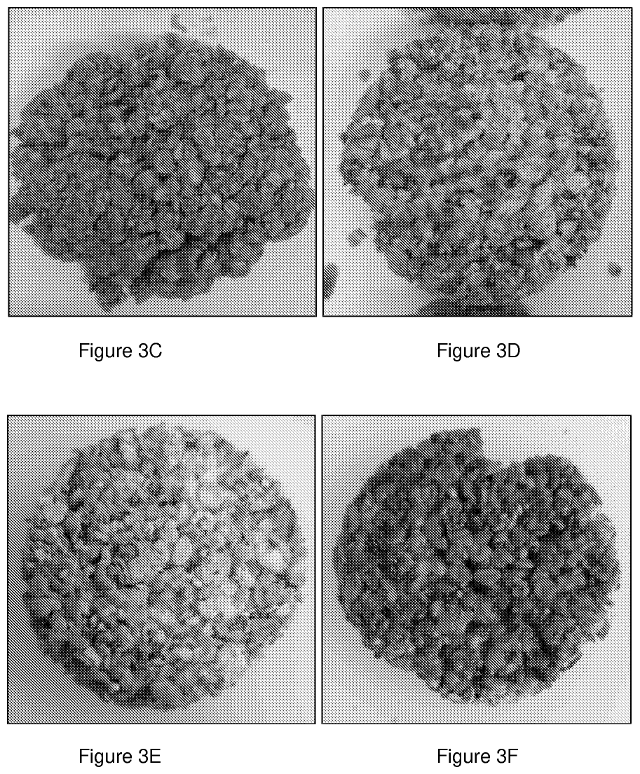

An exemplary method to prepare a textured protein food product based on rapid solid state fermentation includes the steps of:
A) Mixing
   1) Fermented plant ingredient biomass with 30-50% moisture, fermented for 12-20 h with filamentous fungal culture. As the fungal culture, preferably at least one proteolytic Aspergillus strain is used; Aspergillus oryzae is the most preferred strain (such as, from “Solid-state Fermentation” in FIG. 1).
   2) High moisture plant biomass with 50-80% moisture (e.g. press cake from umami sauce production-such as “Press cake” in FIG. 1, or plant based purees and pastes, such as “Vegetables, spices, fats” in FIG. 1)
B) Shaping (or forming) the mixture into e.g. sheets, cakes, patties or balls—“Forming under press” in FIG. 1
C) Culturing (or fermenting) the biomass for 4-24 h, preferably 12-24 h
D) Optionally heating and cooling the product (such as by baking or frying)
E) Optionally adding spices or marinade
F) Packaging

This results in a myelinated substrate that has a solid, juicy and chewable texture comparable to the texture of typical meat substitutes (in FIG. 1 referred to as Solid formed product). After a baking step the texture is firm, juicy and not dry, although the water content is relatively low. The flavour profile is salty and umami rich due to the fungal functions and may utilize the side streams of the umami sauce making process. This texturization process takes no longer than 1-2 days and uses low energy by utilising heat from rapid fungal growth.

### Example 2

### Recipe:

670 g fermented biomass (470 g fresh peas, 200 g oat flakes)
250 g umami sauce press cake
50 g vegetable oil
30 g sundried tomato cubes

Fermented biomass is produced by inoculating a mixture of fresh field peas and oat flakes with a rapidly growing, proteolytic strain of Aspergillus. The mixture is fermented at 26-30 C and RH 80-100% for 12-20 h, until the mixture has a mildly yeasty aroma and some visible mycelia on the surface of peas.

Fermented biomass is mixed with 250 g press cake from umami sauce production, 50 g oil and 30 g sundried tomato cubes. The mixture is pressed into perforated molds with ø=10 cm. Pressing is performed in a manner conserving the packing density such that the formed product in the molds has internal free spaces for filamentous fungal growth. Molds are placed in a chamber with RH=80-100% for 12-24 h. After culturing, the formed patties are pan fried and ready to eat without further seasoning or processing.

### Example 3

### Sensory Profile of Plant-Based Patties Produced With Aspergillus Strains

Plant-based patties produced with Aspergillus strains were prepared by using a pea-oat mixture as a substrate. The fermentations were carried out in similar conditions as described in Example 2. The recipe to form the patties contained 85% fermented pea-oat mixture, 13.8% umami sauce press cake (of which 35% salt) and 1.2% onion powder in dry matter basis. The targeted moisture content of the fermented patties was approximately 59% to support the growth of the fungi. Water was added to obtain the desired moisture level. Control samples were prepared similarly except no fungal spores were introduced to the mixture. Instead, methyl cellulose was used as a binder. The recipe for the control samples was as follows (in a dry matter basis): 80% pea-oat mixture, 5% methylcellulose, 13.8% umami sauce press cake (of which 35% salt) and 1.2% onion powder. The obtained moisture content for the control samples was approx. 65%. The final salt concentration in all patties was 2%. The patties were pan-fried before sensory evaluation.

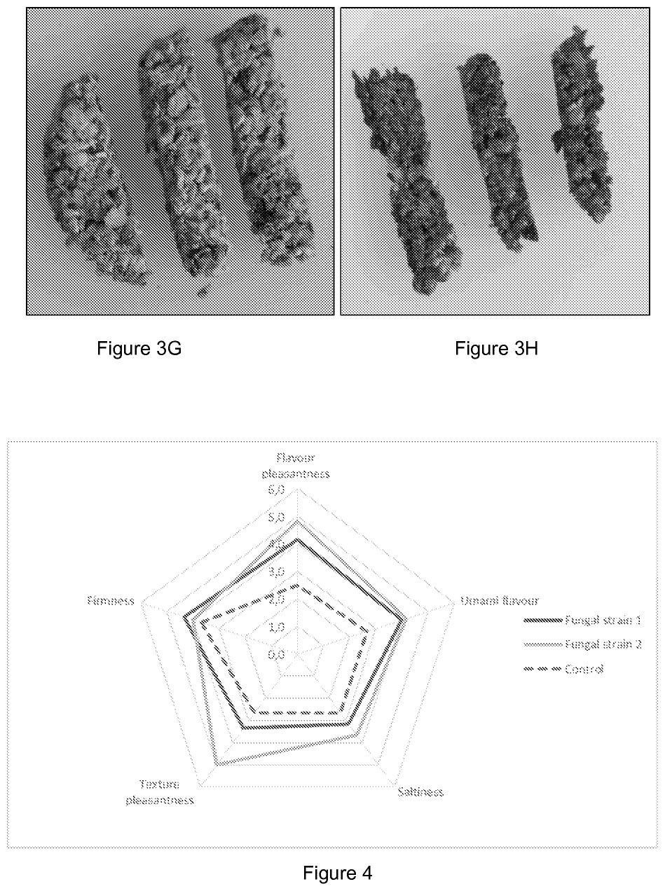

The sensory evaluation was performed with a sensory panel consisting 6 assessors. The assessors were instructed to evaluate the intensities of 5 attributes (flavour pleasantness, saltiness, umami flavour, texture pleasantness and firmness) on a 0-7 scale. The results of the evaluation are presented in FIG. 4. Overall, fermentation enhanced the flavour and texture pleasantness of the patties. In addition, umami flavour was perceived more intensely in patties introduced with fungi compared to control patties.

### REFERENCES

Jeleń, H., Majcher, M., Ginja, A., & Kuligowski, M. (2013). Determination of compounds responsible for tempeh aroma. Food Chemistry, 141(1), 459-465.
Wiebe, M. (2002). Myco-protein from Fusarium venenatum: a well-established product for human consumption. Applied microbiology and biotechnology, 58(4), 421-427.

1. A method of manufacturing a texturized formed plant protein product, comprising the steps of:
i) providing a bed substrate comprising plant-based protein-containing particles, said particles forming a mass of material having a packing density comprising internal free spaces;
ii) introducing at least one filamentous fungal culture into the bed substrate by mixing such that the fungal culture at least partly enters the internal free spaces;
iii) incubating to convert the bed substrate to a pre-fermented bed substrate in which the fungal culture has at least partly reached mycelial stage;
iii-a) combining the pre-fermented bed substrate, for adding flavor, with at least one ingredient comprising salt, resulting in a salt concentration of less than 3% by weight, preferably 0.1% to less than 3% by weight;
iv) shaping the pre-fermented bed substrate to a formed product in a manner conserving the packing density such that the formed product has internal free spaces for filamentous fungal growth; and
v) fermenting the formed product to provide a texturized formed plant protein product by a substantially solidifying filamentous fungal growth via the internal free spaces.

2. The method according to claim 1, wherein the bed substrate has a moisture content between 25% to 75% by weight.

3. The method according to claim 1,
wherein the salt is or comprises at least one of sodium chloride, potassium chloride, magnesium sulphate, or lysine hydrochloride, and wherein step iii-a) is performed after step iii) and before step iv).

4. The method according to claim 1, wherein in fermentation step v) amount of extractable glutamic acid increases, wherein the amount of extractable glutamic acid in the texturized formed plant product is at least 4 g/kg dry matter, or the amount of extractable glutamic acid in the texturized formed plant protein product is at least quadrupled compared to the amount of extractable glutamic acid in the bed substrate.

5. The method according to claim 1, wherein the bed substrate comprises plant protein suitable for releasing umami ingredients and wherein in step v), umami ingredients are released inside the formed plant protein product through fermentation by the fungal culture.

6. The method according to claim 1, wherein the bed substrate comprises plant protein suitable for releasing umami amino acids when the bed substrate comprises at least 1400 mg/100 g glutamic acid.

7. The method according to claim 1, wherein the bed substrate comprises at least 5% by weight carbohydrates.

8. The method according to claim 1, wherein pH of the bed substrate is in the range of 4.8 to 6.8.

9. The method according to claim 1, wherein the plant-based protein-containing particles have a size distribution selected so that the internal free spaces allow mass transfer and substrate availability for the fungal culture, wherein the internal free spaces have a diameter of 0.2 to 5 mm.

10. The method according to claim 1, wherein the packing density is sufficiently low to enable air circulation through the mass of material, in other words the mass of material being aerated.

11. The method according to claim 1, wherein the packing density is between 0.20 and 0.40 kg/dm³.

12. The method according to claim 1, wherein the bed substrate comprises at least one component retaining moisture during the fungal growth, such as fiber.

13. The method according to claim 1, wherein the method further comprises the step of:
vi) heating the formed product, such as by frying or baking, to deactivate the filamentous fungal culture.

14. The method according to claim 1, wherein the incubation in step iii) is carried out for at least 12 h or less than 24 h.

15. The method according to claim 1, wherein the fermentation in step v) is carried out for a period of time ranging from 12 hours to 7 days.

16. The method according to claim 1, wherein the ingredient comprising salt comprises or consists of a plant-based puree or paste.

17. The method according to claim 1, wherein the bed substrate comprises raw natural material selected from cereals, legumes, oil seeds, nuts, pseudocereals, tubers, fruits, vegetables, and any mixtures thereof.

18. The method according to claim 1, wherein the filamentous fungal culture is selected from a culture of Aspergillus, Rhizopus, Geotrichium, Penicillium, Lentinula, Pleurotus, Auricularia, Agaricus, Flammulina, Hericium, Clitocybe, Hypsizygus, Sparassis, Ustilago, Fusarium and any combination thereof, or comprises at least one Aspergillus subspecies.

19. The method according to claim 18, wherein the filamentous fungal culture is or comprises Aspergillus oryzae.

20. A texturized formed plant protein product produced by the method according to claim 1.

21. The texturized formed plant protein product according to claim 20, wherein the texturized formed plant protein product is a vegetable meat-imitation patty or a vegetable meat-imitation ball.

22. A food product comprising the texturized formed plant protein product according to claim 20.

23. The method according to claim 1, wherein the method further comprises the step of:
vii) adding spices, herbs or marinade.
